(19) United States
(12) Patent Application Publication
(10) Pub. No.: US 2024/0279986 A1
(43) Pub. Date: Aug. 22, 2024

(54) CONTROLLER FOR CONTROLLING ASCENDING/DESCENDING OF A ROLLER SHADE

(71) Applicant: SHANG HUI MACHINERY CO., LTD., Kaohsiung City (TW)

(72) Inventor: Ming-Lu Wong, Kaohsiung City (TW)

(21) Appl. No.: 18/112,902

(22) Filed: Feb. 22, 2023

(51) Int. Cl. E06B 9/68; E06B 9/42

(52) U.S. Cl. CPC E06B 9/68; E06B 9/42; E06B 2009/6809

(57) ABSTRACT

A controller for controlling ascending/descending of a roller shade includes a switch box, a drive cord, a cord engagement unit and a control rod. A top end section of the drive cord is wound on a rotary shaft of a cord winder of a roller shade. A rear end section of the drive cord is conducted into the switch box. Two cord sections between the top end section and the rear end section of the drive cord are separated by a guide seat of the cord engagement unit and respectively passed through a cord shifting seat of the cord engagement unit to be driven and displaced. The cord sections are further connected with a spring and enclosed in the control rod. When rotating the control rod, the cord shifting seat is driven to transversely move, whereby the two cord sections are synchronously driven to displace to the same side. At this time, a cord section on one side is selectively clamped by a first gear or a second gear of the cord engagement unit to limit the move of the cord section and secure the cord section to the switch box. When the switch box is pulled, the roller shade is controlled to move upward or downward.

### BACKGROUND OF THE INVENTION

### 1. Field of the Invention

The present invention relates generally to a controller for controlling ascending/descending of a roller shade, and more particularly to a controller capable of preventing a child from pulling a pull cord and twisting the pull cord around the child's neck.

### 2. Description of the Related Art

A conventional roller shade often employs a bead chain controller or a pull cord to control ascending/descending of the roller shade fabric. The bead chain controller is drivingly connected with a roller shade tube. When pulling the bead chain, the bead chain controller is rotated to drive and rotate the roller shade tube so as to lift or lower the roller shade fabric. When the bead chain controller stops driving and moving the roller shade fabric, the bead chain of the bead chain controller naturally suspends from one side of a window to a lower edge of the window without being located. The bead chain is not secured so that a space sufficient for the bead chain to twist around a neck is exposed. As a result, it is easy for a child to pull the bead chain and twist the bead chain around the child's neck to cause fatal injury. Therefore, in use of the conventional roller shade, the suspending bead chain may lead to unexpected danger.

In order to solve the problem that the conventional bead chain is not secured so that a child may twist the bead chain around the child's neck to cause danger, a bead chain securing device has been developed. Such bead chain securing device has a securing unit disposed at the tail end of the suspending bead chain. The securing unit is fixed on the wall to locate the bead chain and prevent a child from pulling the bead chain and twisting the bead chain around the child's neck. Such securing unit can locate the bead chain. However, the bead chain exposed to outer side still has a gap so that a sufficiently large dangerous space still exists to allow a child to pull the bead chain and twist the bead chain around the child's neck. Moreover, it often takes place that the securing unit is not installed as required. In this case, the bead chain will still threaten the life of the child. Therefore, the conventional bead chain securing device is not an optimal design.

### SUMMARY OF THE INVENTION

It is therefore a primary object of the present invention to provide a roller shade controller capable of effectively preventing a child from pulling the pull cord and enhancing safety effect. The roller shade controller includes a drive cord wound on a rotary shaft of a cord winder of the roller shade. Two cord sections between a top end section and a rear end section of the drive cord are separated by a guide seat with two rows of dentations, whereby the two cord sections are positioned on outer sides of two movable gears. The two cord sections are respectively passed through two notches on two sides of a cord shifting seat drivable by rotation of a control rod. When rotating the control rod, the cord shifting seat is driven to transversely move, whereby the two cord sections are synchronously driven by the cord shifting seat to transversely displace. A rear end section of the drive cord is conducted into the control rod to connect with a spring and locate. When rotating the control rod, the cord shifting seat is driven to transversely move, whereby the two cord sections are synchronously driven to displace to the same side. At this time, a cord section on one side is attached to a movable gear, while the other cord section on the other side leaves the other movable gear. When the switch box is pulled downward, the movable gear on one side moves upward along the row of dentations of the guide seat and the cord section to clog the cord section of the drive cord on one side and restrict the cord section from moving. Accordingly, the cord section on one side is located on the switch box to form a pull end. Under such circumstance, the control rod and the switch box together pull the drive cord to drive the rotary shaft of the cord winder of the roller shade to clockwise or counterclockwise rotate and make the roller shade move upward or downward. The drive cord is concealed in the control rod so as to prevent a child from pulling the bead chain or pull cord and twisting the bead chain or pull cord around the child's neck and enhance safety effect.

To achieve the above and other objects, the present invention provides a controller for controlling ascending/descending of a roller shade. The controller includes a switch box, a drive cord, a cord engagement unit and a control rod. The switch box is composed of a first case body and a second case body. Each of upper and lower ends of the first and second case bodies has a dent. After the first and second case bodies are assembled with each other, an opening is formed at each of the upper and lower ends of the switch box. Two protruding posts are respectively disposed on two lateral sides of the upper end opening. A first roller and a second roller are respectively fitted on the protruding posts. An elongated channel is formed at a middle portion of each of the first and second case bodies. The two elongated channels are correspondingly assembled with each other. The drive cord has the form of a loop body. A top end section of the drive cord is wound on a rotary shaft of a cord winder of the roller shade. The drive cord serves to drive the rotary shaft to clockwise rotate or counterclockwise rotate so as to control ascending/descending of the roller shade. A rear end section of the drive cord is conducted through the opening of the upper end of the switch box into the switch box and then conducted out of the switch box through the opening of the lower end of the switch box. Two lateral sections of the drive cord are enclosed in the switch box. The cord engagement unit includes a guide seat, a movable gear set including a first movable gear and a second movable gear and a cord shifting seat. The guide seat is disposed at an inlet end of the opening of the upper end of the switch box. The guide seat is a substantially triangular body, whereby the opening of the upper end of the switch box is divided into two inlets. The two lateral sections of the drive cord are respectively conducted through the two inlets into the switch box. The two lateral sections of the drive cord are separated and positioned on outer sides of the first and second movable gears. Two rows of dentations are disposed on two sides of the guide seat through the thickness thereof. The first movable gear or the second movable gear is engaged with the row of dentations and is up and down movable along the row of dentations. The cord shifting seat is positioned in the elongated channel of the middle portion of the switch box. Two notches are respectively formed on two sides of the cord shifting seat. The two lateral sections of the drive cord are respectively conducted through the two notches, whereby the two lateral sections of the drive cord can be driven by the cord shifting seat to synchronously displace to the same side. An arcuate recess is formed on the cord shifting seat between the two notches. The first and second movable gears of the cord engagement unit are positioned in the arcuate recess. In addition, a toothed engagement seat perpendicularly protrudes from the cord shifting seat. Multiple engagement teeth are formed on an inner face of the toothed engagement seat. A drive body is disposed at an upper end of the control rod. The drive body has multiple engagement blocks corresponding to the engagement teeth, whereby the engagement teeth are engaged with the engagement blocks. When rotating the control rod, the engagement blocks of the drive body drive the engagement teeth so as to drive the cord shifting seat to transversely displace. In addition, multiple engagement teeth are disposed at the upper end of the toothed engagement seat of the cord shifting seat. The engagement teeth cooperate with a locating unit to limit the moving distance of the cord shifting seat. The control rod is a hollow tubular body. The drive body is disposed at the top end of the hollow tubular body. The engagement blocks are formed on the drive body for drivingly engaging with the engagement teeth of the toothed engagement seat of the cord shifting seat. A rear end section of the drive cord is conducted into the control rod and connected with a cord conducting seat and a spring and located at a rear end of the control rod. The rear end section of the drive cord is concealed in an internal space of the control rod.

With respect to the technical theory of the present invention, the top end section of the loop-shaped drive cord is wound on the rotary shaft of the cord winder of the roller shade, while the rear end section of the drive cord is conducted through the switch box to connect with the control rod. When rotating the control rod, the cord shifting seat is driven to transversely displace. At this time, the two separated cord sections of the drive cord are driven to displace to the same side. The cord section of the drive cord on one side is selectively attached to the first movable gear or the second movable gear of the cord engagement unit, while the cord section of the drive cord on the other side is reversely not attached to the first movable gear or the second movable gear. When the control rod is pulled downward to synchronously move the switch box downward, the first movable gear or the second movable gear leant against the cord section is moved upward along the row of dentations of the guide seat to clog the cord section and restrict the cord section from displacing so as to form a pull end. At this time, the control rod and the switch box together downward pull the drive cord on one side, the rotary shaft of the cord winder of the roller shade is driven to clockwise rotate or counterclockwise rotate. Accordingly, the roller shade is controlled to move upward or downward. Then, by means of the spring connected with the drive cord, the control rod and the switch box are synchronously moved upward and restored to their home positions for selection between ascending and descending of the roller shade. Accordingly, the operation can be repeated to control the ascending/descending of the roller shade.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view of the cord shifting seat of the present invention;

FIG. 3 is a sectional assembled view of the present invention;

FIG. 4 is a perspective assembled view of the present invention;

FIG. 5 is a perspective view of the controller of the present invention;

FIG. 6 is a perspective view showing that the controller of the present invention is connected with a cord winder of a roller shade;

FIG. 7 is a side view showing that the controller of the present invention is connected with a cord winder of a roller shade;

FIG. 8 is a view showing the locating unit of the present invention;

FIG. 9 is a side view showing the operation of the present invention;

FIG. 10 is a view showing that the rotary shaft of the cord winder is counterclockwise rotated;

FIG. 11 is a view showing that the cord shifting seat of the present invention is transversely displaced; and

FIG. 12 is a view showing that the rotary shaft of the cord winder is clockwise rotated.

### DETAILED DESCRIPTION OF THE PREFERRED EMBODIMENTS

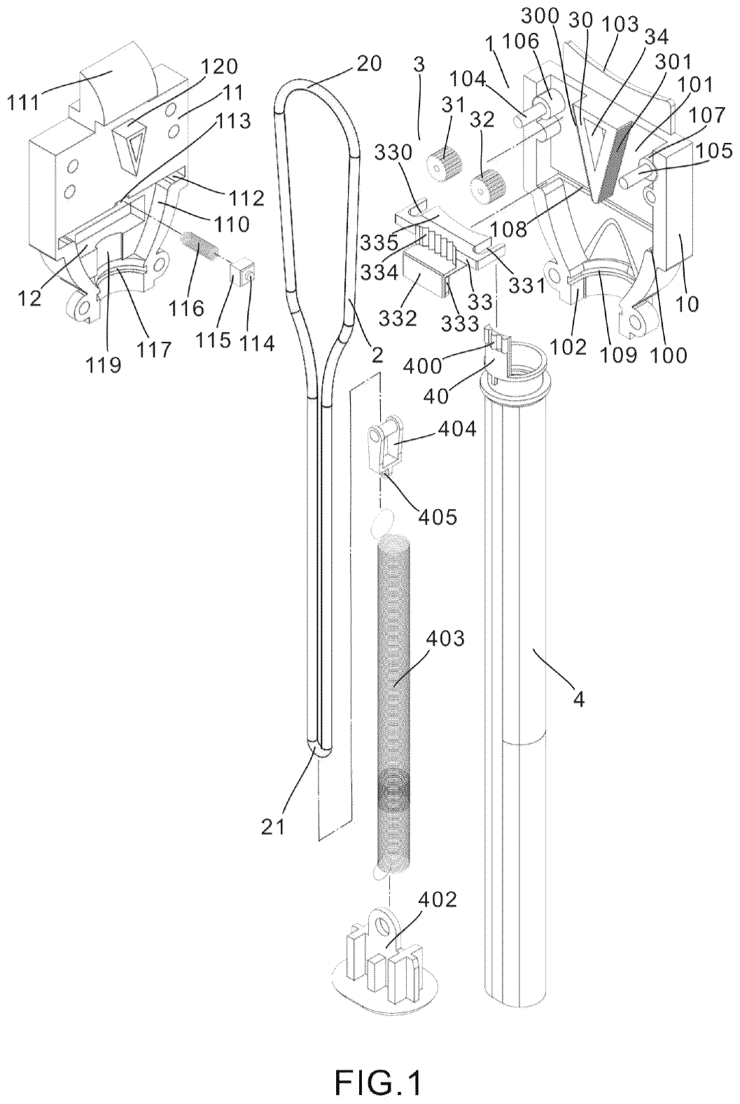

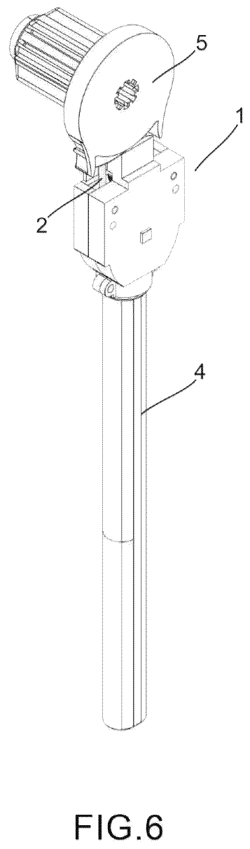

Please refer to FIG. 1. The present invention includes a switch box 1, a drive cord 2, a cord engagement unit 3 and a control rod 4. The switch box 1 includes a first case body 10 and a second case body 11. An inner face of the first case body 10 is formed with an inward recessed structure 100. An upper end and a lower end of the inward recessed structure 100 are respectively formed with an upper end dent 101 and a lower end dent 102. A locating plate 103 protrudes from an outer side of the upper end dent 101. In addition, two protruding posts 104, 105 are disposed on two lateral sides of the upper end dent 101. A first roller 106 and a second roller 107 are respectively movably fitted on the protruding posts 104, 105. An inner face of the second case body 11 is also formed with an inward recessed structure 110. A locating body 111 protrudes from an upper end of the second case body 11. A locating block 120 is disposed on the inner face of the second case body 11 under the locating body 111. An elongated channel 108 and an elongated channel 112 are respectively formed at middle portions of the inward recessed structures 100, 110 of the first and second case bodies 10, 11. The two elongated channels 108, 112 correspond to each other. A receiving sink 113 is further formed on a bottom of the elongated channel 112 of the second case body 11. A locating unit 118 is positioned in the receiving sink 113. The locating unit 118 is composed of a cap body 115 with an abutment column 114 and an elastic member 116. By means of the elastic member 116, the abutment column 114 has elasticity. In addition, a restriction channel 109 and a restriction channel 117 are respectively formed at lower ends of the first and second case bodies 10, 11 near the lower end dents. A top end structure of the control rod 4 is received in the restriction channels 109, 117, whereby the top end structure of the control rod 4 is held between the first and second case bodies 10, 11 and connected with the switch box 1. An arcuate depression 119 is formed above the restriction channel 117 of the second case body 11 in communication with a receiving cavity 12. A toothed engagement seat 332 of a cord shifting seat 33 is received in the receiving cavity 12. When the first and second case bodies 10, 11 are assembled with each other by means of securing members to form the switch box 1, two openings are respectively formed at the upper and lower ends of the switch box 1 and a receiving space is defined in the switch box 1. The drive cord 2 has the form of a loop body. A top end section 20 of the drive cord 2 is wound on a rotary shaft of a cord winder (with reference to FIG. 6). The drive cord 2 serves to drive the rotary shaft of the cord winder 5 to clockwise rotate or counterclockwise rotate so as to control ascending/descending of the roller shade. A rear end section 21 of the drive cord 2 is conducted through the opening of the upper end of the switch box 1 into the switch box 1 and then conducted out of the switch box 1 through the opening of the lower end of the switch box 1. Two lateral sections of a middle portion of the drive cord 2 are enclosed in the switch box 1. The cord engagement unit 3 is disposed in the internal space of the switch box 1. The cord engagement unit 3 includes a guide seat 30, a movable gear set including a first movable gear 31 and a second movable gear 32 and a cord shifting seat 33. The guide seat 30 is disposed at an inlet end of the opening of the upper end of the switch box 1 and extends to an edge of the elongated channel 108 of the first case body 10, whereby the opening of the upper end of the switch box 1 is divided into two inlets. A locating socket 34 is formed on an end face of the guide seat 30. The locating block 120 of the second case body 11 is plugged and located in the locating socket 34. In addition, two rows of dentations 300, 301 are disposed on two sides of the guide seat 30 through the thickness thereof. The two rows of dentations 300, 301 separate the first and second movable gears 31, 32 of the movable gear set on two sides of the guide seat 30, whereby the first and second movable gears 31, 32 are movable along the two rows of dentations 300, 301. The cord shifting seat 33 is positioned in the elongated channel 108 of the middle portion of the switch box 1. Two notches 330, 331 are respectively formed on two sides of the cord shifting seat 33. The inner edges of the notches 330, 331 are formed with arcuate faces 336. In addition, a toothed engagement seat 332 perpendicularly protrudes from the cord shifting seat 33. The toothed engagement seat 332 is received in the receiving cavity 12 of the second case body 11. Multiple engagement teeth 333 are formed on an inner face of the toothed engagement seat 332. A drive body 40 is disposed at an upper end of the control rod 4. The drive body 40 has multiple engagement blocks 400 corresponding to the engagement teeth 333, whereby the engagement teeth 333 are engaged with the engagement blocks 400. When rotating the control rod 4, the engagement blocks 400 of the drive body 40 drive the engagement teeth 333 so as to drive the cord shifting seat 33 to transversely displace. In addition, multiple engagement teeth 334 and an arcuate recess 335 are disposed at the upper end of the toothed engagement seat 332 of the cord shifting seat 33. The engagement teeth 334 cooperate with the abutment column 114 of the locating unit 118 to limit the moving distance of the cord shifting seat 33. The first and second movable gears 31, 32 are positioned in the arcuate recess 335. The control rod 4 is designed as a hollow tubular body. The drive body 40 is disposed at the top end of the hollow tubular body. The engagement blocks 400 are formed on the drive body 40 for engaging with the engagement teeth 333 of the cord shifting seat 33. In addition, a tube cap 402 is securely fitted in a tail end of the hollow tubular body. A top end of the tube cap 402 is securely connected with a bottom end of a spring 403. A top end of the spring 403 is securely connected with a perforation 405 of a cord conducting seat 404. The rear end section 21 of the drive cord 2 is conducted through a conducting space defined by the cord conducting seat 404 to connect with the spring 403.

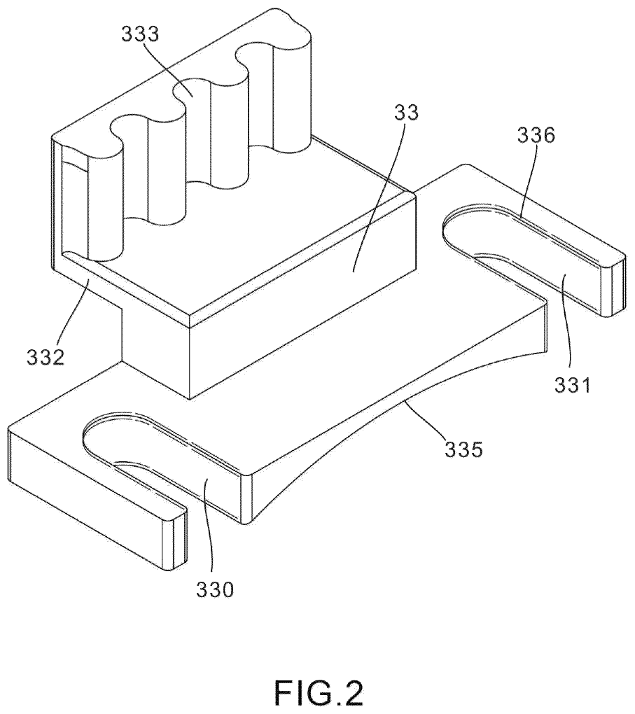

With reference to FIGS. 1, 2 and 3, the present invention is assembled by means of the following steps:

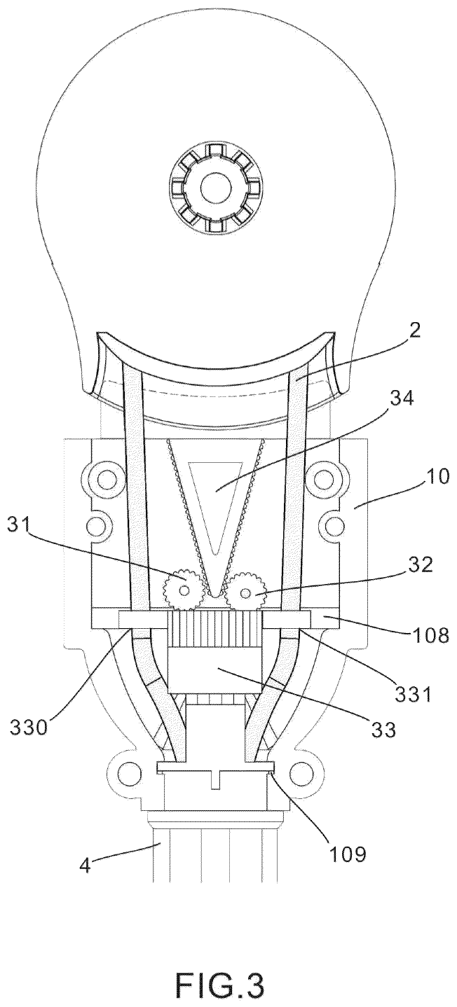

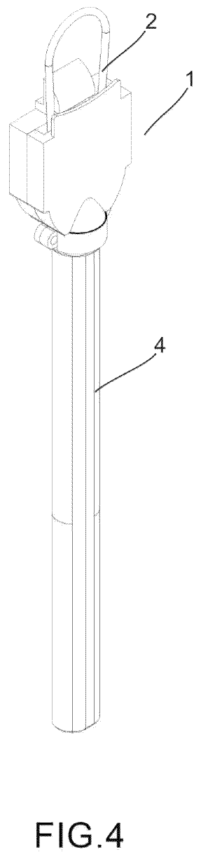

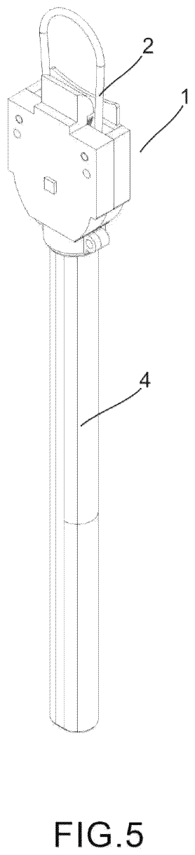

The two cord sections of the middle portion of the loop-shaped drive cord 2 are respectively arranged in the two inlets of the first case body 10. Then the two cord sections are wound on the outer circumferences of the first and second movable gears 31, 32 to pass through the elongated channel 108 of the first case body 10. Then the cord shifting seat 33 is placed into the elongated channel 108, whereby the two cord sections are conducted through the notches 330, 331 on two sides of the cord shifting seat 33 of the cord engagement unit 3. In addition, the rear end section 21 of the drive cord 2 is conducted through the opening of the tail end of the first case body 10 and finally conducted into the hollow tubular body of the control rod 4 to connect with the cord conducting seat 404. The top end of the spring 403 is securely connected with the perforation 405 of the lower end of the cord conducting seat 404. The rear end of the spring 403 is located by means of the tube cap 402 (as shown in FIG. 1). Accordingly, the rear end section 21 of the drive cord 2 and the spring 403 are enclosed in the control rod 4. Thereafter, the upper end structure of the control rod 4 is connected in the restriction channel 109 of the first case body 10. Also, the engagement blocks 400 of the drive body 40 are drivingly engaged with the engagement teeth 333 of the toothed engagement seat 332 of the cord shifting seat 33 (with reference to FIGS. 1 and 3). After the drive cord 2 and the cord engagement unit 3 and the control rod 4 are arranged in the inward recessed structure 100 of the first case body 10, the second case body 11 are mated with the first case body 10, whereby the locating block 120 of the second case body 11 is plugged into the locating socket 34 of the guide seat 30 and connected therewith. The assembled main body of the switch box 1 is connected with the control rod 4 by means of securing members (with reference to FIGS. 4 and 5). Finally, the top end section 20 of the drive cord 2 extending out of the switch box 1 is hung on the rotary shaft of the cord winder 5. In this case, by means of rotating and pulling the control rod 4, the roller shade can be controlled and selectively moved upward or downward (as shown in FIG. 6).

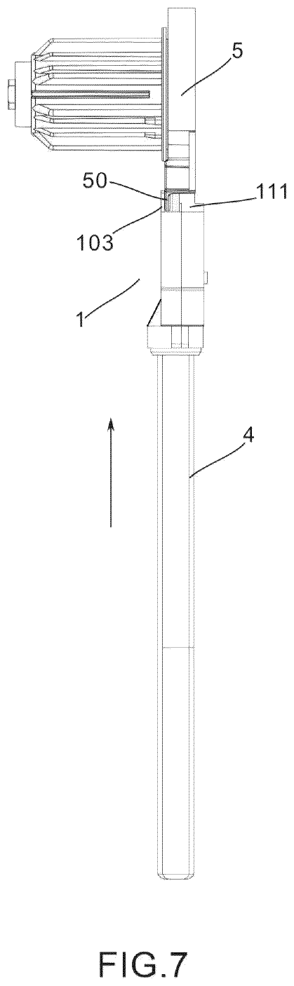

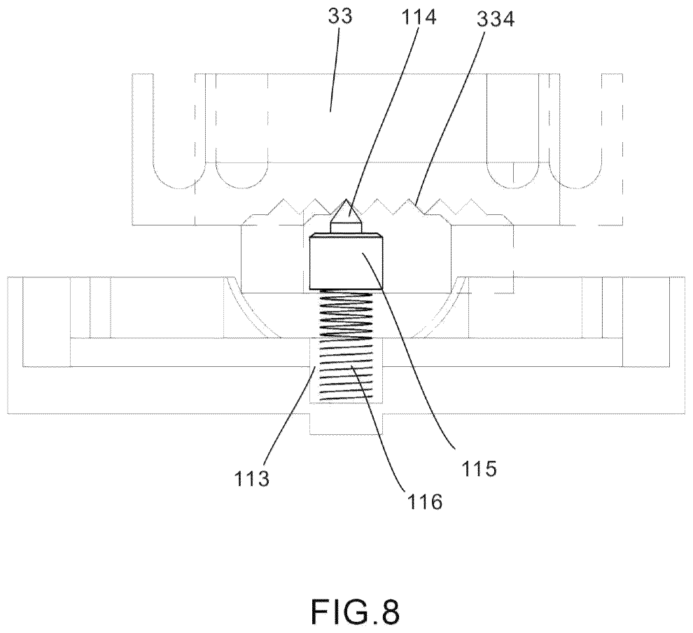

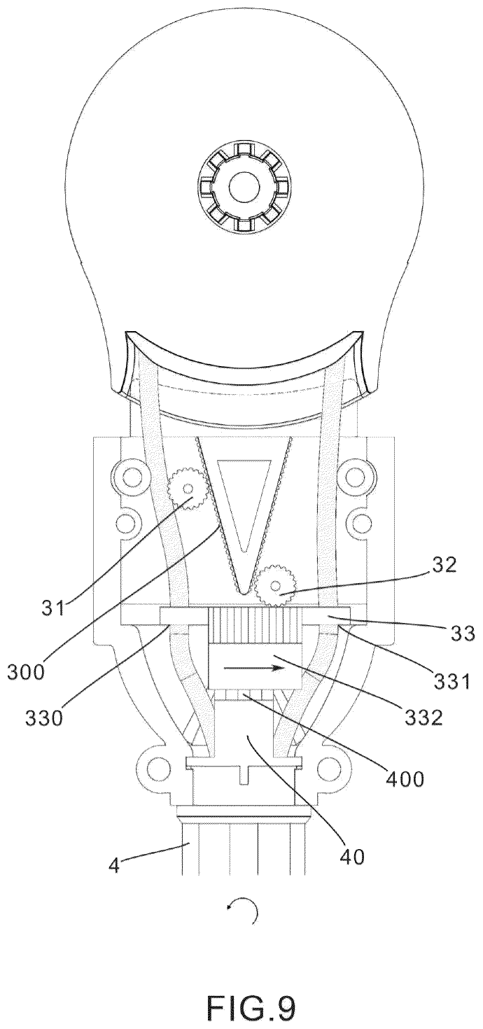

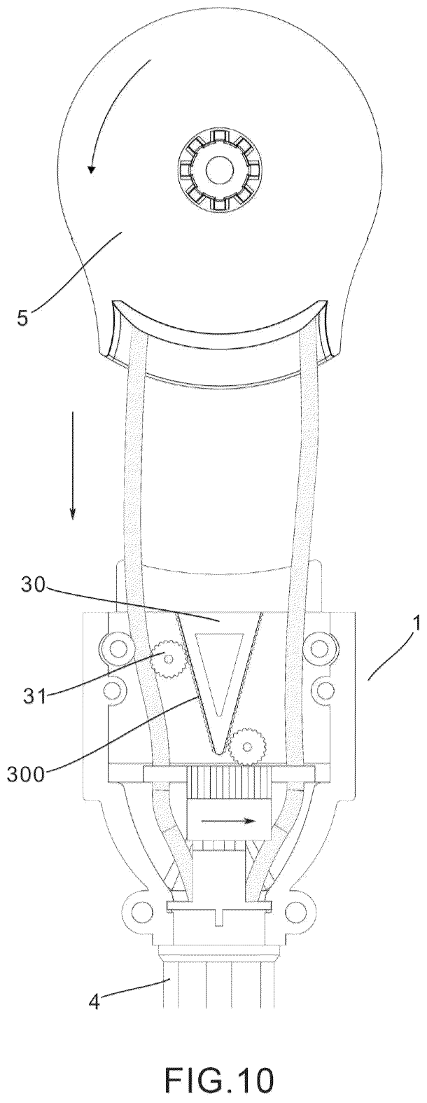

Please now refer to FIGS. 7 to 10, which show the operation of the present invention. When the roller shade is operated and controlled to move upward or downward, a protection board 50 of lower end of the cord winder 5 is clamped between the locating plate 103 and the locating body 111 of the upper end of the switch box 1 (with reference to FIG. 7). The switch box 1 is stopped by the protection board 50 so that the control rod 4 can be conveniently rotated without rotating the switch box 1 along with the control rod 4. When it is desired to upward wind the roller shade (with reference to FIG. 9), the control rod 4 is counterclockwise rotated. At this time, the engagement blocks 400 of the drive body 40 of the upper end of the control rod 4 is synchronously moved to drive the toothed engagement seat 332 of the cord shifting seat 33 to transversely rightward displace. At the same time, the two cord sections passing through the two notches 330, 331 of the cord shifting seat 33 are synchronously transversely rightward moved. In addition, the cap body 115 is disposed on the bottom of the receiving sink 113 and the elastic member 116 elastically pushes the cap body 115 to make the abutment column 114 thereof forward abut against the engagement teeth 334 and locate (with reference to FIG. 8) so as to prevent the cord shifting seat 33 from further displacing. Accordingly, the cord section on the right side is deflected from the second movable gear 32, while the first movable gear 31 is leant against the cord section on the left side (with reference to FIG. 9). When the control rod 4 and the switch box 1 are pulled downward, the first movable gear 31 leant against the cord section on the left side is displaced upward along the row of dentations 300 of the guide seat 30 to clog the cord section on the left side and form a pull end. Under such circumstance, the control rod 4 and the switch box 1 together pull the cord section downward (with reference to FIG. 10) to drive the rotary shaft of the cord winder 5 to counterclockwise rotate and make the roller shade move upward.

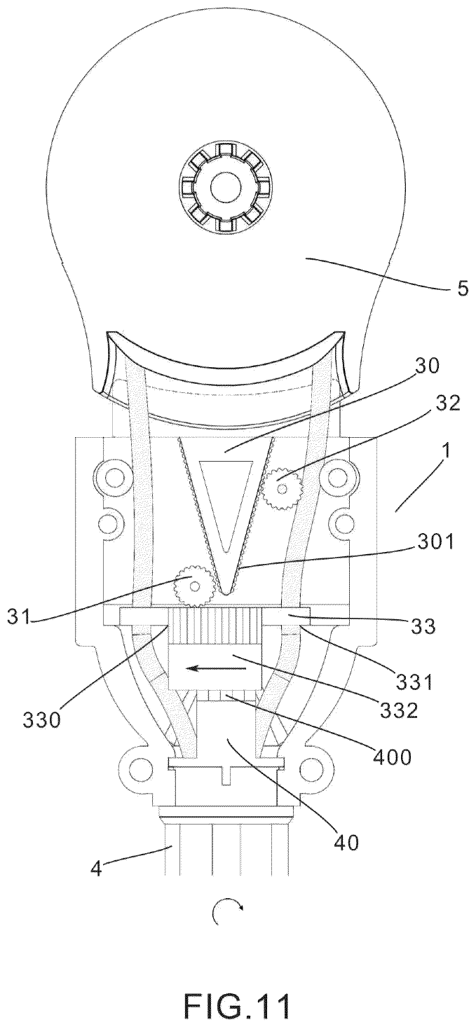

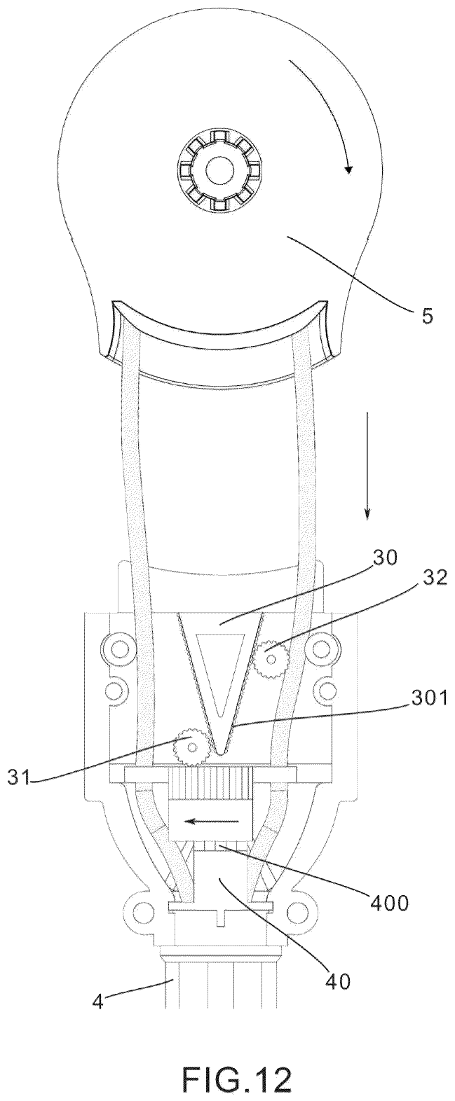

When it is desired to operate and move the roller shade downward (with reference to FIG. 11), the control rod 4 is reversely operated. That is, the control rod 4 is clockwise rotated. At this time, the engagement blocks 400 of the drive body 40 of the upper end of the control rod 4 is synchronously moved to drive the toothed engagement seat 332 of the cord shifting seat 33 to transversely leftward displace. At the same time, the two cord sections passing through the cord shifting seat 33 are synchronously transversely leftward moved. Identically, the abutment column 114 of the cap body 115 disposed on the bottom of the receiving sink 113 abuts against the engagement teeth 334 and locate (with reference to FIG. 8) so as to prevent the cord shifting seat 33 from further displacing. Accordingly, the cord section on the left side is deflected from the first movable gear 31, while the second movable gear 32 is leant against the cord section on the right side. When the control rod 4 and the switch box 1 are pulled downward, the second movable gear 32 leant against the cord section on the right side is displaced upward along the row of dentations 301 of the guide seat 30 to clog the cord section on the right side and form a pull end. Under such circumstance, the control rod 4 and the switch box 1 together pull the cord section downward to drive the rotary shaft of the cord winder 5 to clockwise rotate and make the roller shade move downward (with reference to FIG. 12).

The above embodiments are only used to illustrate the present invention, not intended to limit the scope thereof. Many modifications of the above embodiments can be made without departing from the spirit of the present invention.

What is claimed is:

1. A controller for controlling ascending/descending of a roller shade, comprising a switch box, a drive cord, a cord engagement unit and a control rod, the switch box being composed of a first case body and a second case body assembled with each other, each of upper and lower ends of the switch box having an opening, a top end section of the drive cord being wound on a rotary shaft of a cord winder, a rear end section of the drive cord being conducted through the opening of the upper end of the switch box into the switch box and then conducted out of the switch box through the opening of the lower end of the switch box to extend into the control rod and connect with a spring, whereby two lateral sections of the drive cord are enclosed in the switch box and assembled with the cord engagement unit, the cord engagement unit being mounted in the switch box, the cord engagement unit including a guide seat disposed at the opening of the upper end of the switch box, two rows of dentations being disposed on two sides of the guide seat through the thickness thereof, the opening of the upper end of the switch box being divided by the guide seat into two inlets for separating the drive cord to pass through the two rows of dentations on two sides of the guide seat, the controller for controlling ascending/descending of a roller shade further comprising a movable gear set including a first movable gear and a second movable gear, the first and second movable gears being movably disposed on two sides of the guide seat, a cord shifting seat being transversely movably mounted in the switch box, two notches being respectively formed on two sides of the cord shifting seat, a toothed engagement seat perpendicularly protruding from the cord shifting seat between the two notches, engagement teeth being formed on the toothed engagement seat for limiting the cord sections of the drive cord to respectively pass through the notches of two sides of the cord shifting seat, whereby when the cord shifting seat is transversely moved, the cord sections of the drive cord are driven to synchronously move toward the same side and selectively attach to the first movable gear or the second movable gear, the control rod being mounted in the switch box, the control rod including a drive body disposed at the upper end of the control rod, multiple engagement blocks being disposed on the drive body, the engagement blocks being engaged with the engagement teeth of the cord shifting seat, whereby when rotating the control rod, the cord shifting seat is driven to synchronously transversely move, when the control rod with the switch box is pulled downward, the first movable gear or the second movable gear leant against the cord section of the drive cord being upward moved along the row of dentations of the guide seat to clog the cord section and form a pull end, whereby the control rod and the switch box together pull the cord section downward to drive the rotary shaft of the cord winder to clockwise or counterclockwise rotate and make the roller shade move upward or downward.

2. The controller for controlling ascending/descending of a roller shade as claimed in claim 1, wherein the two notches are respectively formed on two sides of the cord shifting seat, inner edges of the notches being formed with arcuate faces, the cord sections of the drive cord being limited to pass through the notches, whereby when the cord shifting seat is transversely moved, the cord sections of the drive cord are synchronously transversely moved.

3. The controller for controlling ascending/descending of a roller shade as claimed in claim 1, wherein the toothed engagement seat perpendicularly protrudes from the cord shifting seat, multiple engagement teeth being formed on the toothed engagement seat and engaged with the engagement blocks of the top end of the control rod, whereby when rotating the control rod, the engagement blocks drive the engagement teeth so as to drive the cord shifting seat to transversely displace.

4. The controller for controlling ascending/descending of a roller shade as claimed in claim 1, wherein multiple engagement teeth are formed on a plane face of the upper end of the cord shifting seat, whereby when the cord shifting seat is transversely moved, an abutment column of a locating unit abuts against the engagement teeth so as to restrict the cord shifting seat from further displacing.

5. The controller for controlling ascending/descending of a roller shade as claimed in claim 1, wherein an elongated channel is further disposed in the switch box, a receiving sink being formed on a bottom section of the elongated channel for receiving a locating unit, the locating unit including a cap body and an elastic member, an abutment column being disposed at an upper end of the cap body, the elastic member being mounted at a lower end of the cap body, the elastic member serving to elastically push the cap body so as to keep the abutment column abut against the engagement teeth of the upper end of the cord shifting seat.

6. The controller for controlling ascending/descending of a roller shade as claimed in claim 1, wherein an arcuate recess is formed on the plane face of the upper end of the cord shifting seat, the first and second movable gears being positioned in the arcuate recess respectively corresponding to the two rows of dentations on two sides of the guide seat.
